(19) United States
(12) Patent Application Publication
(10) Pub. No.: US 2014/0207678 A1
(43) Pub. Date: Jul. 24, 2014

(54) DISBURSEMENT AND SETTLEMENTS SYSTEM AND METHOD

(71) Applicant: Robert Conyers, Montreal (CA)

(72) Inventor: Robert Conyers, Montreal (CA)

(21) Appl. No.: 14/158,934

(22) Filed: Jan. 20, 2014

Related U.S. Application Data
(60) Provisional application No. 61/754,751, filed on Jan. 21, 2013.

(51) Int. Cl. G06Q 20/40

(52) U.S. Cl. CPC G06Q 20/40
USPC 705/44

(57) ABSTRACT

A system conducts online person-to-person monetary transactions between individuals or between individuals and entities such as banks, merchants or other companies. An individual establishes an electronic payment user interface associated with an entity which gives access to an online system used to transact money transfers. Any user can complete a receipt or a payment transaction directly with any other person or entity in real-time and at any time and from anywhere providing that each user operates an account from or to which money can be received or disbursed.

### FIELD OF THE INVENTION

The above-mentioned invention relates to payment and settlement systems, and more particularly to an on-line electronic money transfer system and methodology. The invention is particularly useful in effecting person-to-person (for example face-to-face, ‘two party’) financial transactions. It operates in the context of both transaction types that the payments system handles and that can occur within and across national borders, namely non-intermediated and intermediated transactions. (See Annotation I at Page 5 below).

### BACKGROUND

Numerous disbursement and settlement schemes facilitating transactions between payers and payees are well known in the art. These schemes provide the mechanisms we generally use to effect financial transactions with one another. Some of these schemes are long-established, for example cash, cheques, money orders or drafts, and some schemes are state-of-the-art automated systems, for example those that may process recurring payments or recurring direct deposits between payors and payees.

Normally, one or more of these schemes could be used by any one person or entity to transact with any other person or entity. Typically transactions generally depend on a mechanism commonly known in the art as a demand deposit account (DDA). A DDA is typically a transaction account, for example a chequing account or a savings account held at service providers such as a banks and financial institutions which may be deposited to or withdrawn from by the customer generally at any time.

Typically, the schemes that could be used by any one person or entity to transact with any other person or entity are separated as a customer might enter into agreements with one or more service providers, and, might enter into one or more agreements in each service provider regarding specific payments and settlements to be made out of money available in an account. For example a customer may enter into one or more agreements with their service provider (e.g. a bank) to authorize making pre-planned or recurring payments from his account, and then enter into one or more separate agreements with that service provider or with an entirely different service provider to make ad hoc (e.g. unplanned or non-recurring) payments and settlements from that same account or from an other account which the customer may elect to have or which may be may be required for those purposes by the service provider.

Normally, each agreement requires specific protocols for their operation. For example, a customer maintaining their account and their pre-planned payments authorizations in the same service provider is nevertheless obliged to enter into separate agreements to make ad hoc payments or to make payments to non-recurring or unplanned payees, or to make payments to new recurring or planned payees.

A typical consequence of an individual entering into and operating these agreements is the furnishing and transmission of confidential information. By way of example, a customer entering into an agreement to operate a demand deposit account with a service provider, e.g. a bank, is normally supplied a Card, such as a Debit Card, which the customer may then use to transact, for example, with merchants on-line. Such transactions typically may require a customer to enter into agreements with each of these entities or with service providers associated with these entities, or may require a customer to enter into agreements with one or more entities or intermediaries through which e-commerce transactions may be made with these entities. Typically, to use these various electronic payments schemes, a customer entering into these agreements to make payments, a payor, is required to divulge some form of personally identifiable information. There is currently no manner for an individual to enter into such agreements in an online environment without giving away some form of personally identifiable information. The more information the customer transmits over the Internet, the greater the likelihood that his confidentiality will be breached.

As increasing numbers of customers become connected to the Internet, the number of electronic payments increases proportionately, as does the risk of breaching confidential information.

Typically, customers have multiple transaction needs and experience a wide range of circumstances and contexts in which they may effect their day-to-day transactions. As more and more customers become connected to the Internet, they typically adopt a range of mechanisms to meet their transaction needs. The more agreements the customer may enter into the greater the divulgation of personal identifiable information and the greater the likelihood that such information will be compromised.

Additionally, it is often difficult for persons or entities to effect money transfers without having to use a ‘paper’ method such as a cheque, money order, draft or cash; card transactions are not widely available for individuals. (An illustrative scenario is shown in Annotation II at Page 6 below).

Accordingly, it is desirable to provide disbursement and settlement systems for effecting on-line transactions between payors and payees without the need to use cash, write cheques or purchase money orders or drafts. It is further desirable to provide methods that will lower the frequency of transmitting confidential information and thereby reduce the risk of compromising personally identifiable information. It is also desirable to provide systems and methods that will reduce the necessity for individuals to enter into multiple agreements to meet their online transaction needs.

### SUMMARY OF THE INVENTION

The fundamental structure of the invention disclosed in this document relates to an integrated on-line disbursement and settlement system by which a customer is able, within the scope of a single agreement between him and a service provider to establish and effect any one or more of:

1. payment of money to any payee whether pre-planned, recurring or not,
2. receipt of money from any payor whether pre-planned, recurring or not,
3. directly debit or deposit the money paid or received from any payor or payee respectively as above in 1 and 2,
4. archive the transaction details
5. issue and communicate confirmation and related information of any transaction entered into between the parties.
6. other related capabilities such as payments scheduling or payments reminders.

The invention described herein will serve as electronic alternative and/or replacement to payment by the use of long-established ‘paper’ methods, such as cash, cheques, money orders and drafts. Typically these methods are used to settle obligations which are generally casual, spontaneous, unplanned or non-recurring. Normally, these methods are used as alternatives to, for example, credit cards as the payor and/or payee may not be a card accepter, or may not have a credit card or if the payor does have a credit card, payor may not prefer to use it. Typically these paper methods themselves do not lend themselves to automation.

The invention described herein will also serve as an alternative to paying obligations stemming from traditional, or legally regulated, invoicing methods, such those issued by utilities, credit-granting institutions or merchants. Typically, the payments arising from these obligations are recurring and/or pre-planned, can usually be paid electronically and lend themselves to automation.

In summary, the invention described herein provides a customer with: (1) an integrated online functionality to effect the operations noted above autonomously from any one or more of the elements of disbursement and settlement schemes which may be offered by the entity, which may be a bank or financial institution, in which customer may have an account or accounts; (2) an alternative to disbursement and settlement schemes such as those commonly known as Mobile Banking, On-line Banking or ‘Apps’ associated with and/or proprietary to a particular entity in which customer may have an account or accounts; (3) an alternative to pre-planned payee authorization mechanisms that these schemes, referred to in 2 above, may typically require, (4) an alternative to traditional paper methods, such as cash, cheques, drafts and money orders, and (5) an alternative to a Credit Card.

With respect to the foregoing summary and to the illustrative systems and methodologies described below, it is to be understood by those skilled in the art, that one or more of the elements of the invention may be embodied with and/or utilized in combination or in sub-combination with any one or more of the elements of disbursement and settlement schemes that entities, such as banks or financial institutions, may offer to customers. Accordingly it will be appreciated and understood that combinations or sub-combinations as such may be made without departing from the true spirit and scope of the invention. The disclosure is thus to be regarded as conjunctive instead of restrictive on the operation and implementation of the present invention.

### DIFFERENTIATION

Though most consumers' transacting occurs in a wide range of circumstances and is done in an ad hoc, unplanned manner, some on-line transacting approaches claiming to help are increasingly offered in the marketplace. These are either DDA-based or non DDA-based approaches. For example, the Royal Bank Financial Group's on-line and mobile banking applications (www.rbcroyalbank.com/online/), or TD's EasyWeb Internet banking (www.tdcanadatrust.com/products . . . /banking/ . . . banking/easyweb.jsp) offer a range of tools to assist consumers in paperless bill-paying, organizing recurring payments or sending money to individuals or entities not registered in ‘standing instructions’. These DDA-based ‘build-outs’ extending existing, long-established off-line DDA functionalities to the web do not encompass ‘face-to-face’ transacting and other features offered by the spontaneous online payment system.

The other state-of-the-art web-based systems, that is non DDA-based, claim to help in ways similar to the DDA-based approaches. For example, organizations known as acquirers such as Pay Pal or money transfer concepts methods and systems such as ‘money cards’ offer a range of tools to help consumers make payments, send money, pay on-line, or set up a merchant account. Typically, rather than directly using the demand deposit account of the subscriber, these systems are applications based on the stored value account (SVA) concept allowing subscriber access to a ‘reloadable’ account accessible on-line from which certain types of transactions can be initiated or effected. These schemes do not support ‘face-to-face’ transacting and other features offered by the spontaneous online payment system herein described. (For ease of reference and without unnecessarily expanding the present document, an example of the SVA method and system is described in U.S. Pat. No. 8,126,792.)

In summary, typically the evolution of these offerings stem from long-established functionalities. Accordingly, they are similar, offer characteristics common to each other and while they may claim to do the same things better (ie. Improvements) they cannot claim to doing them differently (ie Innovation).

The applicant believes that none of these offerings currently is providing a comprehensive, spontaneous online payment system and method facilitating face-to-face direct transacting between persons or entities at any time and from anywhere.

### OPERATION

The basic operation of the invention described herein is made possible by the establishment by a user of an electronic payment user interface associated with an entity which gives access to an online system used to transact money transfers as noted in the above Section, Summary.

Machinery and Mechanics—Overview

The functionality of the invention described herein includes the capabilities of collecting, consolidating and processing information and instructions from customers as well as the capacity to give effect to them. The invention described herein is expected to be secure in all respects including the encryption of user-developed criteria stored and/or transmitted over the Internet, geared to helping protect the personal and financial information of users and the parties with whom they transact.

The ‘back office’ machinery that operates the invention is expected to consist of capabilities and technologies such as computers, funds transfer, communications, information capture and reporting that exist presently, as well as new ones.

Many elements of the configurations/combinations of these technologies exist presently. However because it is conceived to facilitate payment and settlement, the invention applies skill and knowledge in a new, practical and innovative manner with distinct commercial utility.

Accordingly the invention achieves a series of new results for users by applying new uses for known things. Also it will apply new ways to make payments and settlements by combining and/or running systems or equipment-process technologies side-by-side, and by bridging ‘gaps’ through ‘patches’ that are custom built for the purpose.

The operation of this invention may be described in the broad context of computer executable instructions, such as program modules being executed by a computer/server or computers/servers. Typically programs modules include operating systems, programs, routines, objects, components, peripherals, data structures, etc., that perform or enable particular operations, perform various or particular operations or implement abstract data types.

This disclosure, or parts of it, may also be effected in distributed computing environments where program modules may be resident in both local and remote computers or devices having, for example, storage media, storage devices or access to such. Typically these environments are linked and may interoperate through communications networks.

Annotation I: Overview of the Payments System

The payments system handles payment flows both within and across national borders.

According to the Bank for International Settlements (BIS), the payments system ‘is a set of mechanisms for the transfer of money among agents. Its constituent elements comprise the institutions providing payment services, the various forms of money, the means of transferring them, including message instructions and communications channels, and the contractual relationships linking the parties.1

Also, according to the BIS, ‘the most common and direct means of settling transactions between non-banks is through the physical transfer of bank notes (‘cash’). Cash transactions are typically non intermediated (‘Two-party transfers’) . . . the transfer of ownership of any other settlement medium takes place by book entry on the accounts of the issuing institution (‘cashless payment’). In this case the payment is performed by intermediaries, which receive and execute instructions to debit the account of the payer and credit that of the payee (customer or ‘third-party transfers’)1

Typically the other forms of settlement media include, for example, Credit Cards, Debit Cards, Signature Debit Card, cheques, certified cheques, money orders, notify and pay, cashier's cheques and drafts. The payment of these other forms of settlement media is performed by intermediaries and hence these transactions are intermediated ones. While Credit Cards and Debit Cards, for example, typically rely on the payment system, they are independent from the payments system, as the features, functionalities and characteristics they themselves furnish are different, distinct and involve alternate choices.

The BIS concludes: ‘Although payment systems differ considerably from country to country, the major participants as well as the key features of the settlement media and transfer mechanisms are quite similar. (C. E. V. Borio and P. Van der Bergh; BIS Economic Papers No. 36, Pages 8-10, Bank for International Settlements, Economics Department, Basle, ISBN 92-9131-034-4, ISSN 1021-2515).

Annotation II: An Illustrative Scenario

Typically, individuals or entities have multiple transaction needs and experience a wide range of circumstances and contexts in which they may effect their ordinary day-to-day transactions. Typically, the majority of these transactions are between individuals and small business people and are spontaneous, unplanned and involve relatively small amounts of money. As illustrated below, deciding the means of payment may frequently involve mitigating financial and personal inconveniences.

By way of an illustrative scenario and commentary, a single working parent, returning home after her night school, needs to pay the baby sitter. She discovers herself short of cash and must turn to ‘solution-finding’ to pay the amount she owes the sitter. She can, for example: despite the obvious inconvenience to the sitter, empty the change out her kids' piggy banks (and then have to remember to top them back up again soon), make an unplanned round trip to the ATM to withdraw the cash she needs, or incur an IOU (necessitating a post-it note on the fridge reminding her to block off time to drive the cash over to the sitter's home in the next day or two, or asking the sitter to come back to collect her money). She could, assuming she's a subscriber herself to such a service, offer to pay the baby sitter using an on-line ‘notify and pay’ type service such as PayPal or Interac Etransfer, only to learn that the baby sitter would have difficulty negotiating the notify and pay instrument at the teller because she's ordinarily in school or at her part-time job during bank opening hours. The parent could also, assuming she has an account with chequing privileges, offer to write the sitter a cheque. While this choice may address the inconvenience with the ‘notify and pay’ option as the sitter could deposit the cheque at the ATM, the sitter has learned that a ‘hold’ on the funds would be applied and she could not have access to her money until the hold period lapses several days after deposit. In the context of other possible options, using her debit card or credit card to pay the baby sitter is futile as neither she nor the baby sitter is an authorized card accepter.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the following description, reference is made to drawings accompanying and forming part of this application and of the invention and its various embodiments, and by which is shown various ways in which the invention may be deployed. It is to be understood that other embodiments that exist presently as well as new ones may be incorporated and structural and functional modifications to them may be made.

Each drawing is referred to as a Figure (Fig) followed by a reference number, for example FIG. 1. So as to impart a more complete synthesis of the disclosure, its attributes and its practice it is intended that the following description be considered together with the drawings below, in which like references indicate like features, and wherein:

FIG. 1 presents a generic computing environment which may operationalize all or some of certain aspects of the disclosure;

FIG. 2 shows an illustrative schema of workstations and servers that may be used to operationalize all or some of the processes and functions of certain embodiments of the disclosure;

FIG. 3 shows an illustrative schema of a system for electronic payment that may be used to operationalize all or some of the processes and functions of certain embodiments of the invention;

FIG. 4 shows a flowchart of an illustrative method for set up and storage of a UI associated with the spontaneous online payment system;

FIG. 5 shows a flowchart picturing an illustrative method for setting up an electronic payment request by a payor;

FIG. 6 shows an illustrative user interface 600 for development of an online electronic payment request;

FIG. 7 shows a flowchart of an illustrative method for setting up an electronic payment request by a payor and payment of an electronic payment by a payor to a payee in accordance with at least one aspect of the present disclosure;

FIG. 8 shows an illustrative completed user interface which may be seen by a user in completing the steps described at FIG. 7;

FIG. 9 shows a flowchart of an illustrative method for setting up an electronic payment request by a payor and payment of an electronic payment by a payor to a payee in accordance with at least one aspect of the present disclosure;

FIG. 10 shows an illustrative completed user interface which may be seen by a user in completing the steps described at FIG. 9.

### DETAILED DESCRIPTION

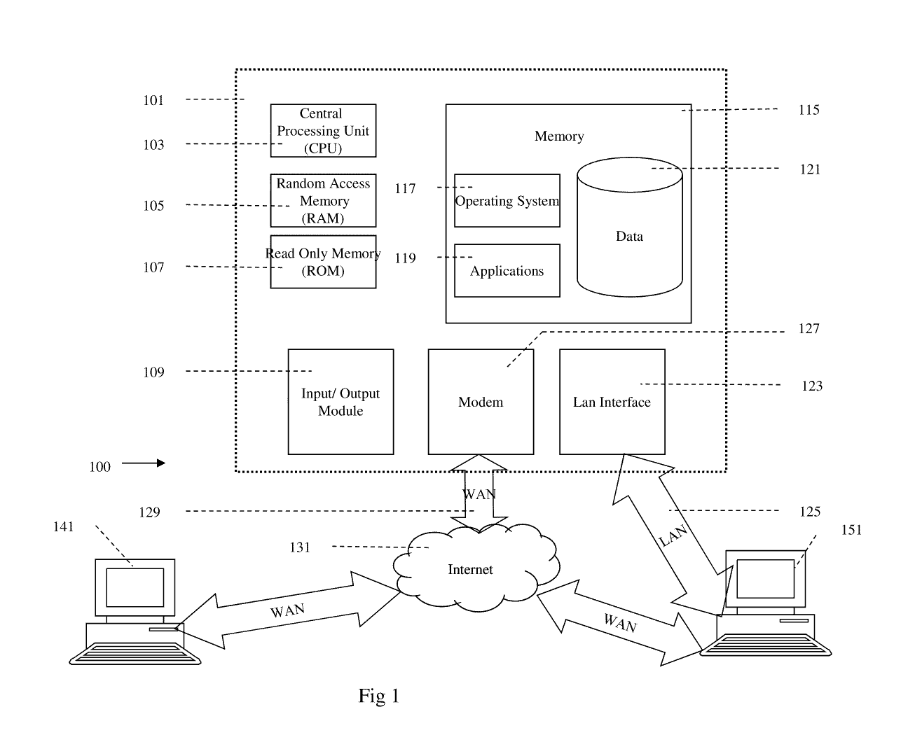

The masculine or feminine genders are used in this document for the convenience of referring to both male and female. FIG. 1 presents a diagram of a generic computing device 101 (e.g., a computer or a server) that may be used according to an illustrative embodiment of the disclosure. Device 101 may operate in a networked environment supporting connections to one or more remote computers, such as terminals 141 and 151. The description of FIG. 1 will provide an illustrative example of the interoperation (shown as 100 in FIG. 1) of device 101 and a networked environment supporting connections to one or more terminals. It is understood that FIG. 1 is one illustrative example.

Typically, the device 101 may have:

A Central Processing unit (CPU) 103 for controlling overall operation of the device and its associated components, such as RAM 105, ROM 107, input/output module 109 and memory 115.

Input/output device 109 may include one or more of but not limited to a keyboard or keypad, touch screen, camera, microphone, dongle, chip card/smart card reader, near field communications (NFC) device, scanner and/or stylus through which a user or other device or media may provide input to device 101, and may also include one or more of a video display device for providing textual, audiovisual and/or graphical output, a printer for providing ‘hard copy’ output, and a speaker for providing audio output. Other input/output devices may be included through which a user and/or other device may provide input/output to/from device 101.

Software may be stored in Memory component 115. This software typically provides instructions used by the CPU to enable the server to perform various functions. Memory component 115 may store software used by device 101, and may, for example, include such elements as an operating system 117 (e.g. Windows), application programs 119 (e.g. Internet Explorer) and a database 121. Memory component 115 may also incorporate hardware or firmware components (not shown) in which are stored executable instructions that may be used by device 101.

Database 121 containing an organized collection of data, such as the storage of the banking information or other characteristics relating to a population of individuals, and as such would permit the interface and interoperation of different elements of the business specific to and/or between one or more locations.

Supporting connections to one or more remote devices, such as devices 141 and 151, facilitating operations of device 101 in a networked environment. Devices 141 and 151 may be, for example, computers, servers, or PDA's having all or many of the characteristics of device 101. The network connections shown in FIG. 1 include a wide area network (WAN) 129 and a local area network (LAN) 125, but may include other networks. When used in a LAN networking environment, the computer 101 is connected to the LAN 125 through a network interface or adaptor 123. When used in a WAN networking environment, the server 101 may include a modem 127 or other means for establishing communications over the WAN, such as the Internet 131. It should be appreciated that device 101 and/or devices 141 and 151 may be mobile terminals incorporating components facilitating mobility such as antennas and batteries (not shown). Byway of example, mobile devices may include such devices as laptops, smart phones, PDA's, or tablets. It is appreciated that the network connections shown are illustrative and other means of establishing communications may be used.

Network interfaces 123 or adapters facilitating connections over networks or a modem 127 or other means associated with device 101 for establishing communications over the internet using protocols well known in the art such as TCP/IP, Ethernet, FTP, HTTP and the like. Additionally, an application program 119 used by the server 101 may include computer executable instructions invoking functionality related to providing access authorization for applications, facilities and networks. FIG. 1 shows a local area network LAN 125 and a wide area network WAN 129, however this disclosure is not limited to these alone and may include other networks and/or multiple connections.

The disclosure is operational with numerous other general purpose or special purpose computing system environments or configurations. Examples of well known computing systems, environments and/or configurations that may be suitable for use with the disclosure include, but are not limited to, personal computers, server computers, hand-held or laptop devices, multiprocessor systems, microprocessor-based systems, set-top boxes, programmable consumer electronics, network PC's, minicomputers, mainframe computers, distributed computing environments that include any of the above systems and devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

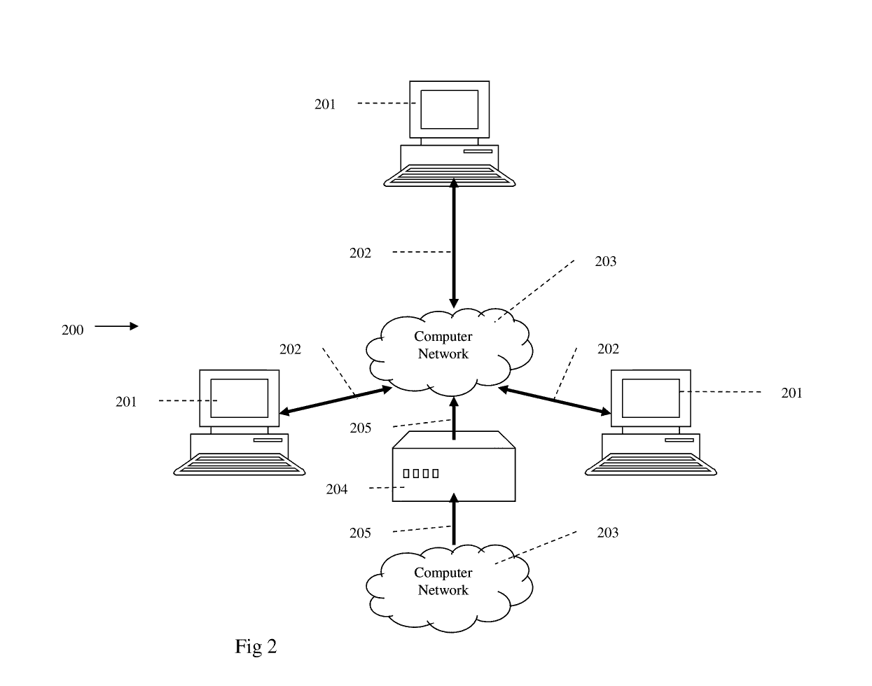

In reference to FIG. 2, the applicant is showing an illustration of system 200 for putting into operation methods of the invention. As shown, system 200 may include one or more workstations 201 that may be local or remote and that are connected by one or more communications links 202 to a computer network 203. Computer network 203 is a collection of computer and other hardware components interconnected by communication channels that include, for example but not limited to, the Internet, a wide area network (WAN), a local area network (LAN), a personal area network (PAN), a virtual Private network (VPN), an intranet, a wireless network (WI-FI), a digital subscriber line (DSL), an asynchronous transfer mode (ATM) or any suitable combination of these or like technologies. The computer network 203 is connected by communications links 205 to server 204. Server 204 may be any suitable data processing device or combination of devices, for example but not limited to, servers, processors or computers. Communications links 202 and 205 may be any communications links suitable for communicating between workstations 201 and server 204 and may include, for example but not limited to, network links, wireless links, wired or cable links, dial-up links, etc.

The disclosures described below may be implemented by any one of or more of the devices/components shown in FIGS. 1 and 2 and by other components, including, for example but not limited to, networks, databases and computing devices.

This disclosure and the various aspects speak to the methods and systems to effect on-line electronic payments between two parties. In this way, as shown in the present disclosure, on-line payments are transacted without requiring the parties transacting together to pre-establish and/or pre-formalize with a financial institution (e.g. a bank) nor with each other their intent to transact together, nor to establish new accounts or funding arrangements prerequisite to facilitate transacting together, and without requiring a payee to receive money upon presentation and negotiation of a notice by email or by other notification media. As such, two parties may spontaneously create and directly effect a transaction on-line together from anywhere and at anytime.

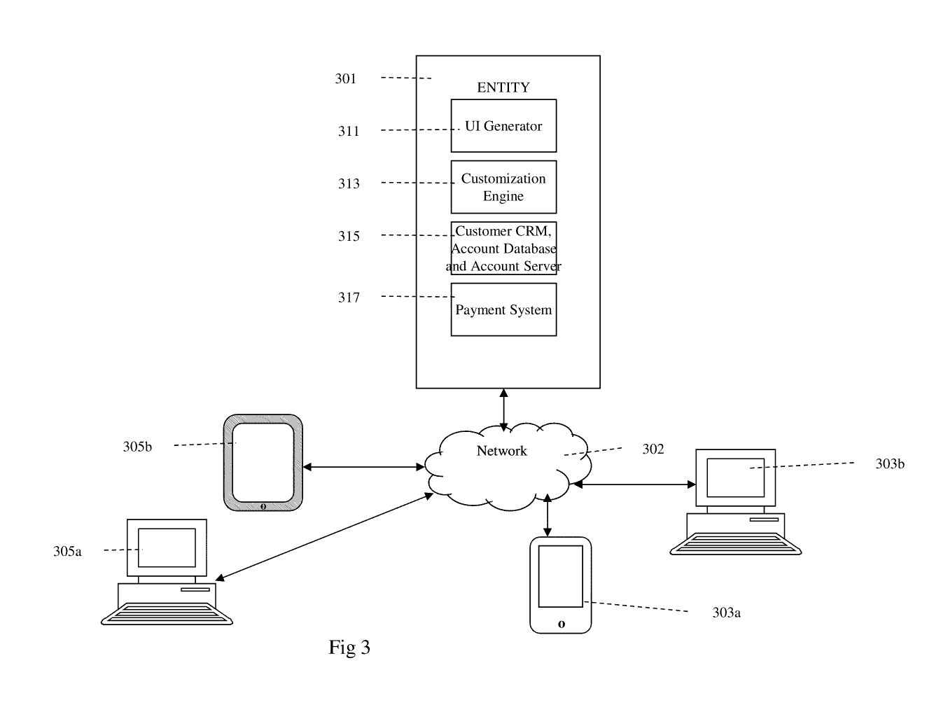

FIG. 3 illustrates in schematic form a system for electronic payment that may be used to implement the processes and functions of certain embodiments of the invention and the disclosures herein, and in accordance with at least one aspect of them. In FIG. 3 is shown an entity 301 which may be an existing entity or a new entity offering a service to its customers in relation to the features described in the present disclosure. For example, Entity 301 may be a financial institution (e.g. a Bank) in which customers may maintain and use demand deposit accounts.

Entity 301 is shown to involve a number of sub-systems. While the sub-systems are shown within entity 301, it is understood that any one or more of them may either reside in entity 301 or be in a physically separate location or be supplied to and/or operated for entity 301 by a service provider or by one or more individuals or entities interoperating with entity 301 and which may be associated with or independent of entity 301. In the case where different entities may perform all or some of the operations of the subsystems, entity 301 would be consolidation of those entities or of the entity directing the operations of the others.

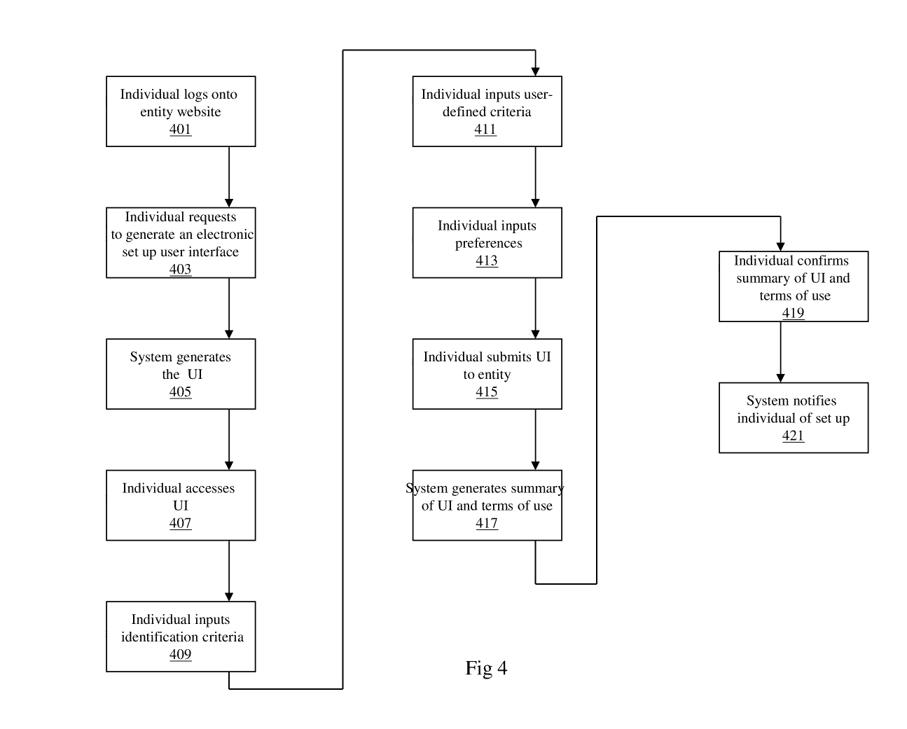

User interface (UI) generator 311, being one of the sub-systems in Entity 301 is configured to generate and store a profile of an individual, for example a payor, wishing to use a capability for spontaneous on-line electronic payment of money directly into an account of a payee. UI generator 311 may include software configured to guide a payor through the process for setting up a UI for day-to-day use by payor of the spontaneous on-line payment service. In accessing the UI generator, a payor 305b may set up and store a UI associated specifically with him for using the service. An illustrative method for set up and storage of such a UI is described below at FIG. 4. Upon set up and storage of a such a UI, UI generator may be configured to generate an Internet address, such as a universal resource locator (URL) permitting payor to access in an online environment the UI associated specifically with him by way of a server that stores the UI. With the URL link to the UI of the payor, payor may access the UI for making payments directly to a payee from anywhere and at any time. Manners for generating and saving such a like UI and the associated functionalities, such as web access, user identification and security, are generally well known and practiced in the art and accordingly will not be described in detail herein. However the present disclosure will provide at FIG. 4 below an illustrative method for setting up and storing such a UI which description shall be understood as being one such scenario.

Payors 305b and 305a may be a single customer of entity 301 that may access the UI generator 311 using a desktop computer 305a and/or by way of a terminal device 305b such as a smart phone or tablet having access to the Internet. In another example, payors 305a and 305b may be different customers that may access his/her accounts and the spontaneous on-line electronic payment service.

Entity 301 incorporates a customization engine, 313 being a subsystem configured to permit a payor to customize and/or modify and store one or more user-defined criteria associated with a UI referred to at 311 above. As shown below at FIG. 4, a payor may use customization engine 313 to modify user-defined criteria such as those created at UI generator 313, and/or to set up or modify other user-defined criteria, for example, user preferences, such as layout of the interface page, colour, font size, etc, or email address or transaction limits, or archiving specifications. Other criteria may also include permitting access to the UI of payor by others, such as by a spouse with whom payor maintains a joint demand deposit account. In another of the various embodiments in which customization engine 313 may be configured, customization engine may permit a payor to disseminate a notification to contacts with whom payor may wish to potentially transact using the spontaneous online payment service. For example, customization engine 313 may be configured to permit payor to disseminate by email to one or more of the persons in a contact list residing, for example in a smart phone or computer, an invitation to set up and store a UI associated with the spontaneous online payment system, as described below at FIG. 4, for day-to-day use of the spontaneous on-line payment service. In another of the various embodiments in which customization engine 313 may be configured, customization engine may permit payor to link to one or more of his contacts in social networking services such as Facebook, Twitter and such, with whom payor may wish to be connected for the purpose of potentially transacting using the spontaneous on-line payment service. Manners for disseminating contact lists, and for generating and storing such a user-defined, customized UI and associated functionalities as exemplified above are well known and practiced in the art, and accordingly they will not be described in detail herein.

Having customized the UI by using customization engine 313, UI generator may provide payor with an Internet address to the UI. The Internet address may be a URL, directing a web-browser to a web page of a server configured to store the customized UI of the payor. With the URL link to the UI of the payor, payor may access the URL for modifying and storing user-defined criteria from anywhere and at any time.

Entity 301 also incorporates a customer and account database 315, being a subsystem configured to maintain accounts of payors, 305b, 305a of the entity 301. In the example where the entity 301 is a financial institution, payor 305b may have a demand deposit account with entity 301 and payor 305b may have a credit card account with entity 301. Customer and account database 315 may maintain data on each distinct account, such as account numbers, entity identifiers, routing numbers, account holder names, passwords and security questions/responses, amounts of money in the account, restrictions regarding debits/withdrawals, service fee schedules, etc. Further to the qualities above, customer and account database 315 may deploy an account server and accordingly customer and account database 315 may be used for authenticating a payor as the person authorized to use a particular account and/or for transacting deposits to or withdrawals from accounts arising in the operation of a spontaneous on-line payment service as described herein.

Entity 301 includes a payment system 317, being a subsystem configured to receive and process instructions for electronic payments to be made between accounts such as those accounts which may be maintained in customer and account database 315. Payment system 317 may be separate from and/or sharing one or more of the attributes of and/or may be interoperating with ‘the payment system’ concept as referred to in Appendix I. Referring back to the structure of entity 301 noted above in FIG. 3, the operations of payment system 317 may not be limited to the operations of accounts in one entity, such as a bank, and accordingly may embrace the operations of one or more entities and those of other organizations involved in processing payment flows.

Payment system 317 may be configured to access customer and account database 315 and to validate the payment criteria for a particular payment desired by the payor. For example, a payor may wish to make a payment by using his debit card. Payment system 317 may be used to determine that the payor may use such a card based upon one or more of the criteria established in the UI, for example, payment system may validate if the debit card associated with payor is valid. If the debit card is found to be invalid, payment system 317 may prevent the payment form being made. In another embodiment of the current description, system 317 may determine if the payment is in compliance with one or more of the criteria residing in customer and account database 315. For example, should payor wish to make a payment that exceeds the money in his account, which account may not be authorized to generate an overdraft, payment system 317 may prevent the payment from being effected.

As described below, according to various embodiments of the description in which the invention may be practised, payment system 317 may also be, for example, configured to charge a fee for the service, which fee may be, for example, instantiated in addition to the amount of the payment or netted from the amount of the payment made by payor. In either instance payment system 317 may be configured to route the fee as charged to the entity or entities performing the service. In the case where more than one entity is involved in performing the service, payment system 317 may be configured to apportion the fee as may be required and to route the respective portions to them. Payment system 317 may also be configured to accept and process specific instructions associated with a particular payment, such as, for example a request by a payor to effect a certain payment at a predetermined time such as at 72 hours from the time of the request.

Entity 301 is shown connected to payors 305b and 305a and payees 303b and 303a by way of network 302. Network 302 may embrace one or more networks connected and interoperating together online in an environment such as the World Wide Web, and may include technologies such as the Internet, wired systems or wireless systems for interconnecting a payor 305b and/or a payee 303b and an entity 301. Network 302 may include either or both internal or external networks to an entity, payor and/or payee. Payors 305b and 305a may each be one of a population of individuals or may be the same individual that may access their UI by way of a browser capable mobile device or terminal such as symbolized in FIG. 3 as tablet 305a and/or by way of a non-mobile device such as symbolized in FIG. 3 as a desktop computer 305a. Payees 303b and 303a may each be one of a population of individuals or may be the same individual that may be using a browser capable mobile device or terminal such as symbolized in FIG. 3 as smart phone 303a, and/or by way of a non-mobile device such as symbolized in FIG. 3 as a desktop computer 303b.

FIG. 4 is a flowchart of an illustrative method for set up and storage of a UI associated with the spontaneous online payment system by an individual wishing to make or receive payments in accordance with at least one aspect of the present disclosure. The description of FIG. 4 will coincide with an illustrative example of implementation of the steps in FIG. 4. It is understood that FIG. 4 is but one illustrative example. It is further understood that numerous technologies and methodologies associated with the set up and storing of such a UI are generally well known and practiced in the art and accordingly they will not be described in detail herein but one or more of these may form part of the implementation of FIG. 4.

The process begins at 401. An individual using a web-enabled device, such as a laptop computer or a tablet, may request access to a home web page of an entity associated with the spontaneous on-line payment service. The access may be based on accessing an Internet address, such as a URL about which individual came to know, for example, autonomously at individual's own initiative, or consequent to a particular enticement, such as advertising, or consequent to a particular stimulus, such as by way of a notification seen by individual consequent to an upload of a contact list described above at FIG. 3 in customization engine, 313. As part of the home page of the entity a link may be seen by individual allowing individual to request generation of a web page with a UI for setting up and storing user-defined and user-specific criteria associated with individual accessing and using the spontaneous online payment system. In this example, at 403 individual looking to initiate the request may click on the link seen in the web page.

Proceeding to 405 system may generate the UI for individual and at 407 individual may access the UI.

Proceeding to 409 system may request individual to input a username and a password associated with the UI. Username may be, for example an email address associated with individual. Password may be, for example, any word or string of characters that may be anticipated by individual to be secret and unique. Although not shown, the process at 409 may include a determination as to whether the criteria entered by individual are allowable by the entity for completion. Further, although such are not described in detail herein, it is to be understood that the process at 409 may implement one or more of numerous identification-related methods and technologies which are typically well known and practiced in the art including but not limited to, for example, those implementing knowledge-based authentication/security questions, or username and/or password selection and/or password assessment. By way of examples, if the email address entered by individual is found to be erroneous, or if the password entered by individual is found not to be of sufficient strength entity may return an error notification to individual. Such notification may be a visual message to individual on the visual display device indicating the specifics of the error to individual. Following such an error notification, process may return a request to correct an error and revert back to 409 whereat individual may correct the error by inputting modified data. If the UI is found to be allowable by entity, the process may proceed to 411.

At 411 individual may input one or more user-defined criteria regarding the use of the UI. Such criteria may include but may not be limited to name, mailing address, telephone number, email address, SIN, Driver's Licence or Passport number, the numbers of one or more bank accounts to which individual has access to deposited funds (e.g. a chequing account or a savings account) and/or bank/credit card numbers. At 411, although not shown, the process may validate whether the criteria entered by individual are allowable for the entity for completion. The entity may confirm that proper information, such as account number, card number, SIN or Passport number, etc. has been entered by individual. Should the UI be found not to be allowable, entity may return an error notification to individual. Such notification may be a visual message to individual on the visual display device indicating the specifics of the error, such as failure to enter a valid SIN, or failure of individual to input into a field requested for completion of the UI, e.g. individual failed to enter any account and/or card number. Following such error notification, process may return a request to correct an error and may revert back to 411 at which individual may correct the error by inputting corrected criteria and/or additional criteria. If the UI is found to be allowable by entity, the process may proceed to 413.

At 413, individual may input one or more user-defined criteria associated with the preferences such as for example layout of the user-specific UI (e.g. colour, language preference, font size, etc.) and/or selecting/deselecting toggles which may relate to certain optional functionalities which may be incorporated in and from part of the implementation of the spontaneous online payment system such as, for example, transaction archiving, contact list management or transaction limit management.

Although not shown in FIG. 4, the process at 413 may validate whether the criteria entered by individual are allowable by entity for completion. Should the UI be found not to be allowable, entity may return an error notification to individual. Such notification may be a visual message to individual on the visual display device indicating the specifics of the error, such as for example, the transaction limit specified by individual exceeds the amount allowable associated with the account which individual selected at 411 above. Following such error notification process may return a request to correct an error and process may revert back to 413 where individual may correct the error by inputting modified criteria and/or additional criteria. If the UI is found to be allowable by entity, the process may proceed to 415.

At 415 individual submits UI to entity. Such submission may be implemented by individual, for example, by pointing to and clicking on a button for that purpose which may be seen by individual in the UI, or by tapping a button for that purpose on a touch screen.

Then at 417 system may generate and display to individual a summary of completed UI and a disclosure of terms and conditions of use associated with the spontaneous online payment system. Such display may be seen by individual on the visual display device and may include a request to individual for confirmation of the completed UI as displayed and acknowledgement of terms and conditions of use. Then at 419 individual may confirm completed UI and acknowledge terms and conditions of use. In the present example, as individual wishes to be associated with the spontaneous online payment system and agrees to the terms and conditions of use, individual returns a notification of acceptance at 419. Such confirmation may be acknowledged by individual to entity by, for example, pointing to and clicking or by tapping a button for that purpose in the UI. With the summary of completed UI and a disclosure of terms and conditions of use generated by entity and confirmed by individual, the UI as completed may be linked by entity exclusively to individual and stored.

Proceeding to 421 system notifies individual of association with the spontaneous online payment system. Such notification may include, for example, a summary of the UI confirmed at 419. The process at 421 may be implemented, for example by displaying a notification to individual on the visual display device and/or by sending a notification to individual which may be disseminated to individual by, for example, email and/or by postal mail at the address inputted by individual at 411. With the notice of association with the spontaneous online payment system generated and linked to individual, the process of the example of FIG. 4 may be complete and the spontaneous online payment system described herein may now be used by individual from anywhere and at anytime.

Returning to FIG. 4, it is understood that, in an alternative instantiation at 419, individual may not wish to be associated with the spontaneous online payment system. Accordingly, although not shown in FIG. 4, the process at 419 may include the optional capability for individual to return a notification of non-acceptance. Such notification may be returned by individual, for example, pointing to and clicking or tapping a button for that purpose on the visual display device. As a consequence of non-acceptance by individual, at 421 system may subsequently return to individual a notification of non-acceptance. Such notification may be a visual message to individual confirming non-acceptance and indicating deletion of all criteria submitted by individual to entity throughout the process described in the example of FIG. 4. With the confirmation of non-acceptance notified to individual the process of the example of FIG. 4 may be complete.

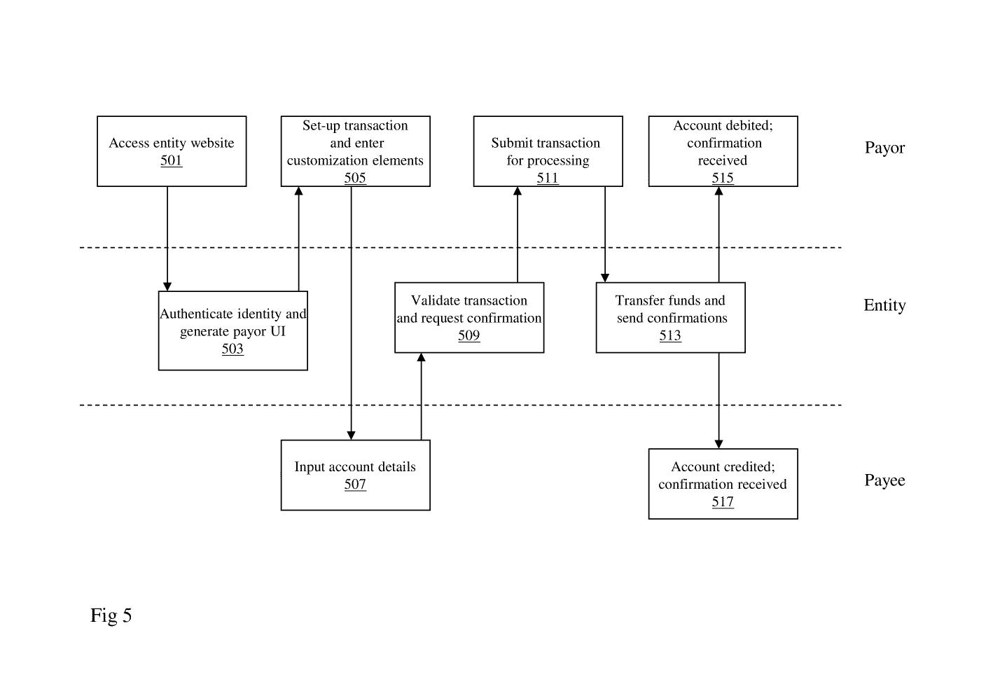

FIG. 5 is a flowchart picturing an illustrative method for online electronic payment in accordance with at least one aspect of the present disclosure. The description of FIG. 5 will coincide with an illustrative example of operationalizing the steps of FIG. 5; however it is to be understood that this is but one illustrative example. For the example of FIG. 5, the dashed lines indicate the operational aspects between a payee, an entity and a payor. The illustrative example considered in FIG. 5 is a payor that discovers herself short of cash upon returning home after night school and is looking to pay her babysitter for minding her children that evening.

Referring to 501 a payor may access an entity website online in order to set up an electronic payment user interface for the payor that is for a transaction. In this example the entity website may be a financial entity where the payor maintains an account which can receive and disburse money, such as a demand deposit account (DDA), or may be another entity interoperating with an entity where the payor maintains such an account. The transaction is the child minding and paying the babysitter the fee associated with minding the children. The access by payor to the entity website may be effected on a web-enabled device by, for example, entering a URL into a browser or by pointing to and clicking on/tapping an icon associated with the website which may be displayed on a monitor/touch screen, or by scanning a square-code or bar-code which may be imprinted, for example, on a card or other media associated with the electronic payment user interface website. In accessing the entity website, entity may generate a payor user interface where payor may have to enter a form of identification and matching password into an online identity authentication system. Other forms of identity authentication may be optionally be used by entity for validation of payor identity, such as, for example, a CAPTCHA code or security questions.

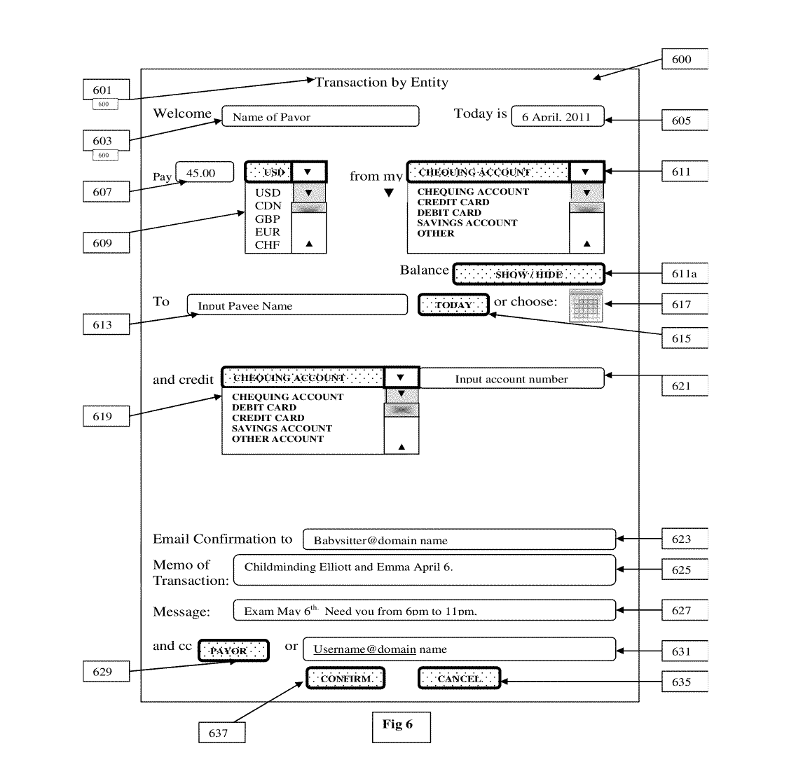

Referring to 503, the entity may permit payor to set up an electronic payment request based on the online authentication of payor identity. Payor may set up a transaction by using a user interface generated by entity. In this example, the user interface may be that developed by payor to set up the elements of the transaction in the example of the baby sitter. Entity may display a user interface for payor. Entity may populate the user interface with certain information corresponding to the user-defined criteria entered and stored as described at FIG. 4. Such information may include, for example, the name of payor and/or one or more of the accounts associated with payor. Entity may generate and show in the user interface and/or associate the ‘buttons’ therein with certain information such as, for example, the calendar date and/or the Email address of payor. FIG. 6 is an illustrative user interface 600 which may be generated at 503 by entity for set up of a transaction by a payor and payment of an electronic payment by a payor to a payee in accordance with at least one aspect of the present disclosure. FIG. 6 will be described below which description will coincide with an illustrative example of implementation of the steps of FIG. 5 in the example of the babysitter.

Returning to FIG. 5, at 503 entity may generate a default user interface for the payor which payor may use where customization may not be needed. In another embodiment of the present disclosure, the entity may optionally permit customization as part of the webpage. In the example of the babysitter the payor may be looking to avoid overdrawing her DDA and may customize the date on which the payment will be made to the babysitter by post-dating the payment for one day to coincide with the credit of her paycheque to her account. Payor may set up the transaction and customization elements at 505.

It is understood that, for this or for any other transaction, any number of options for customizing the user interface may be generated for payor by the entity. For example, payor may wish to suppress a default setting to receive an Email transaction confirmation.

Referring to 507, the entity may generate a request input for the criteria of the account of payee into which the money will be paid. Payee or payor, or payor and payee together may effect such input by means of, for example, keying in a debit card number associated with the bank account of payee, keying in a credit card number associated with the credit card account of payee, scanning the magnetic strip of a debit or of a credit card associated with the bank account of payee, ‘waving’ a contactless smart card or scanning the face of a debit or of a credit card associated with the account of payee on which the payee card number is shown or inputting the MICR encoding of a cheque associated with an account of the payee.

It is understood that the operation of most cards customarily may require a form of user authentication. Typically user authentication may be achieved by the use of one or more of, for example, a personal identification number (e.g. a PIN), a security code or other secret codification such as a password that is shared between the card user and a system which can be used to authenticate the user to the system. It is further understood that operation of such user authentication aspects may comprise part of the operational aspects of the user interface, and as these are generally well known and practiced in the art, they will not be described in detail herein. Although not shown herein, it is understood that entity may, in the example of FIG. 5, generate a request input for such authentication, for example, a PIN.

Proceeding to 509, entity may verify any number of criteria associated with the payor user interface. Should the UI be found not to be allowable for completion, entity may return an error notification to individual. Such notification may be a visual message on the visual display device to the payor indicating the specifics of the error, such as for example insufficiency of funds in payor account, e.g. the payor entered an amount for payment that exceeds the amount of funds in the account, or failure to enter a proper settlement date, e.g. the payor entered a date that has already passed. Following such an error determination, the process may revert back to 507 where individual may correct the error by inputting modified criteria and/or additional criteria. If the UI is found to be allowable by entity in 509, the process may proceed to 511.

At 511, payor may optionally confirm submission of the payor user interface for processing or confirm cancellation of the transaction. Payor may submit the transaction with payee by, for example clicking on or tapping a button which may be seen for that purpose by payor in the payor user interface. Alternatively at 511 payor may cancel the transaction by, for example clicking on or tapping a button that may be seen for that purpose by payor in the payor user interface. Although not shown in FIG. 5 it is understood that upon notification by payor of a cancellation confirmation entity may terminate processing the transaction and discard the transaction elements in the payor user interface set up for the transaction. Since payor, in the example of the babysitter, desires to confirm the transaction with payee, payor enters a confirmation instruction at 511.

Proceeding into 513 entity may effect the transfer of monies from the account of payor as shown at 515 to the account of payee as shown at 517 consistent with the criteria inputted at 507 and the process of the example of FIG. 5 may be complete.

Although not shown at FIG. 5 entity may validate completion of the transfer of monies from the account of payor as shown at 515 to the account of payee as shown at 517. Such notification may be a visual message on the visual display device to the payor. Should the transaction not be completed, entity may return an error notification to individual. Such notification may be a visual message to individual on the visual display device indicating the specifics non-completion, such as network communications failure or account server failure. Following such notification, process may revert back to 511 where payor may optionally confirm submission of the payor user interface for processing or confirm cancellation of the transaction.

As shown by way of the illustrative example described herein in FIG. 5, an on-line payment is transacted between a Payor and a Payee spontaneously without requiring either of the parties transacting together to pre-establish and/or pre-formalize with a financial institution (e.g. a bank) nor with each other their intent to transact together, nor to establish new accounts or funding arrangements prerequisite to facilitate transacting together, and without requiring a payee to receive money upon presentation and negotiation of a notice by email or other notification media.

Although not shown at 513, at 513 entity may implement and apportion any fees associated with the use of the service consistent with the particular manner in which fees are practiced within the spontaneous online payment service. Also at 513 entity may send notifications such as transaction confirmations or other notifications to payor and/or to payee at the addresses, for example the email addresses specified by payor in setting up the user interface as described at FIG. 4. In the example of the babysitter, payor may desire to include in the transaction confirmation to the babysitter a notification to the babysitter reminding to return on a certain date and time to mind her children again.

It is understood that alternatively although not shown at FIG. 5, in another aspect of the present disclosure entity may invoke at FIG. 5, at 507 for example, certain criteria of the UI of payee should payee have established such UI consistent with the process described herein at FIG. 4, for example, autonomously on payee's own initiative or consequent to a particular stimulus or notification to payee such as by way of an upload of a contact list described above in FIG. 3, customization engine, 313. Such criteria may include for example a form of identification and matching password of payee. Entity may be configured to generate such invocation coincident to receiving at 507 the request input of payee account. Entity may be configured to authenticate such request input. Upon authentication of such request input of payee, entity may permit the account of payee into which the money will be deposited.

FIG. 6 is an illustrative user interface 600 for development of an online electronic payment request in accordance with at least one aspect of the present disclosure. UI 600 may be seen by a payor or by a payor and payee together in customization of an electronic payment UI that is for a transaction that is for a payor. Illustrative user interface, FIG. 6 may be the UI developed by the payor or a payor and payee together in the example of the babysitter.

A payor or a payor and payee together may enter and/or customize any number of various user defined criteria regarding UI elements in any of a number of known manners. In the UI 600, a logo 601 of the entity may be shown for advertisement purposes. Entity may generate payor name and date display in the areas 603 and 605 respectively. Although shown as a number of text boxes boxed for entry of text, the system may be configured to provide any number of predefined templates and/or drop down menus where certain fields are pre arranged and others are not.

In the area 607 a payor may enter an amount for payment and in 609 payor may customize the currency of transaction. In area 611 payor may customize the account associated with the payment and at area 611 a payor may request display by entity of the balance of the account so customized. At area 613, payor may input payee name. Payor may specify a transaction date identifying the calendar point when monetary funds may be credited to account of payee; at 615 payor may select ‘today’ or alternatively may select at 617 to customize the transaction date.

In areas 619, 621, 623, 625 and 627 the payor or a payor and payee together may enter additional payee and/or payor defined criteria for inclusion in the electronic payment UI. At 619 the account of payee to which monetary funds will be paid may be selected and at 621 the associated account/card number may be inputted. At 623, the Email address of payee may be inputted for disseminating a communication to payee, which communication may include for the benefit of payee a description of the transaction and any message inputted at 625 and/or 627 respectively.

It is understood that alternatively although not shown at FIG. 6, in another aspect of the present disclosure entity may invoke at FIG. 6 at step 619 for example, certain criteria of the UI of payee should payee have established such UI consistent with the process described herein at FIG. 4, for example, autonomously on payee's own initiative or consequent to a particular stimulus or notification to payee such as by way of an upload of a contact list described above in FIG. 3, customization engine, 313. Such criteria may include for example the Email address of payee and one or more of an account type of payee and associated account number. Entity may be configured to generate such invocation coincident to, for example to entity receiving at 613 the input of payee name. Entity may display one or more of an account type and associated account number of payee at 619 and at 621 respectively, and may display the Email address of payee at 623.

Alternatively to the input method described above at 619, entity may receive account criteria input by for example, scanning the magnetic strip of a debit or of a credit card associated with the bank account of payee, ‘waving’ a contactless smart card or scanning the face of a debit or of a credit card associated with the account of payee on which the payee card number is shown or inputting the MICR encoding of a cheque associated with an account of the payee, etc. as described above at FIG. 5 at 507.

At 629 payor may request receipt of copy of communication to payee which entity may implement by invoking the email address inputted by payor at 411 in the process of FIG. 4 described above. Alternatively, payor may customize input a recipient Email address at 631.

The process proceeds to step 637 at which payor may submit to the system the UI that is for a transaction in the example of the babysitter. At 637 the entity may confirm that proper information has been entered in the UI. Should the UI be found not to be allowable, entity may return an error notification to payor. Such notification may be a visual message to payor on the visual display device indicating the specifics of the error, such as, for example, failure to enter a valid Email address at 631, or failure to input into a field requested for completion of the UI, e.g. failure to enter any transaction date. Following such error notification, process may return a request to correct an error and may revert back to one or more steps of FIG. 6 at which payor may correct the error or errors by inputting corrected criteria and/or additional criteria. If the UI is found to be allowable by entity, the process may return to 637 at which payor may submit the allowable UI to entity.

Alternatively at 635 payor may cancel the transaction. It is understood that upon notification by payor of a cancellation confirmation at 635, entity may terminate the UI and discard the elements in the UI set up for the transaction. Since payor, in the example of the babysitter, desires to confirm the transaction with payee, payor enters a confirmation instruction at 637. Entity may effect the transaction consistent with the UI developed at FIG. 6 and the process of the example of FIG. 6 may be complete.

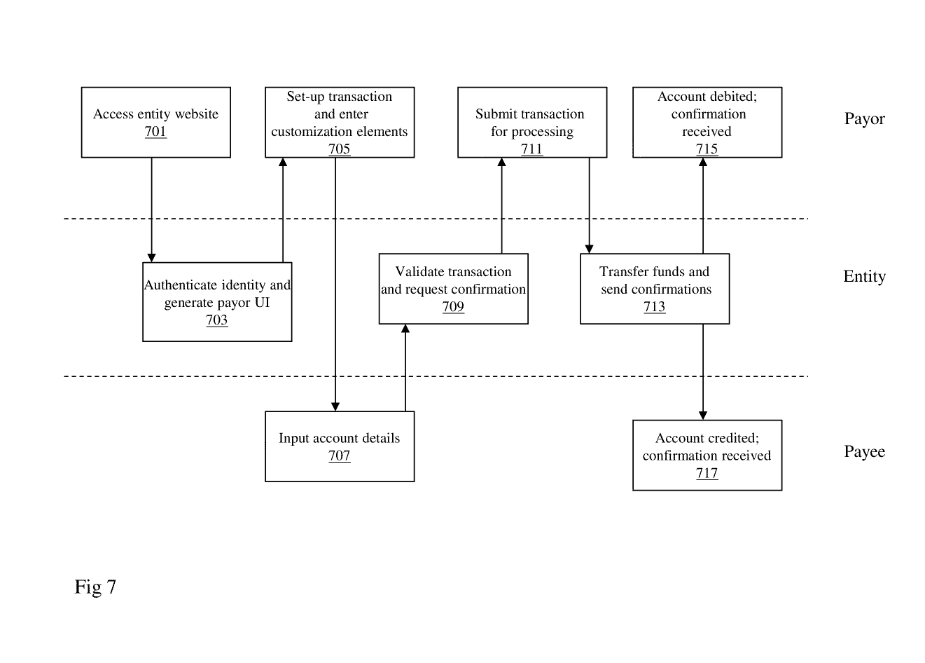

FIG. 7 is a flowchart of an illustrative method for setting up an electronic payment request by a payor and payment of an electronic payment by a payor to a payee in accordance with at least one aspect of the present disclosure. The description of FIG. 7 will coincide with an illustrative example of implementation of the steps of FIG. 7; however it is to be understood that this is but one illustrative example. The illustrative example considered in FIG. 7 is a payor looking to transfer money from her savings account to her chequing account to which her pre-authorized car lease installment is being charged.

In the example of FIG. 7, it is understood that the area assigned as Payor may embody the operational aspects between individual having a chequing account and that the area assigned as Payee may be may embody the operational aspects between individual having a savings account. For the example of FIG. 7, the areas assigned as Payor, Entity and Payee symbolize the operational aspects between a payee, an entity and a payor in the example of the transfer between the savings account and the chequing account. In the description below of FIG. 7 it is understood that payor and payee may be the same individual.

It will be understood by those skilled in the art and its practice, the example of FIG. 7 may comprise one or more of the teachings and implementations of FIG. 5. So as not to encumber the present document by repetition, such teachings and implementations will not be repeated herein the description of FIG. 7, however the disclosure of FIG. 7 below shall be appreciated in conjunction with the teachings and implementations described above at FIG. 5 in the example of the babysitter. It will be further understood that the description of FIG. 7 is associated with a payor who, consequent to having completed the process of the example of FIG. 4 has received notice of association with the spontaneous online payment system according to the teachings and implementations shown at FIG. 4 and accordingly the spontaneous online payment system described herein may be used by payor from anywhere and at anytime.

The process starts and at 701 payor may access an entity website online in order to set up an electronic payment user interface for the payor that is for a transaction. In this example the entity website may be a financial entity where the payor maintains an account which can receive and disburse money, such as a chequing account, or may be another entity interoperating with an entity where the payor maintains such an account. The transaction is the money transfer and paying money from the savings account into the chequing account.

Referring to 703, the entity may permit payor to set up an electronic payment based on the online authentication of payor identity. Payor may set up a transaction by using a user interface generated by entity. In this example, the user interface may be that developed by payor to set up the elements of the transaction in the example of the transfer between accounts. Entity may display a user interface for payor which entity may populate with certain information corresponding to the user-defined criteria entered and stored as described at FIG. 4. Such information may include that information corresponding to the notice of association and the use of the spontaneous online payment system by payor.

Payor may set up the transaction at 705. It is understood that, at 705, any number of options for customizing the user interface may be generated for payor by the entity. For example, at 705 payor may suppress the default setting to send an Email transaction confirmation to the payee.

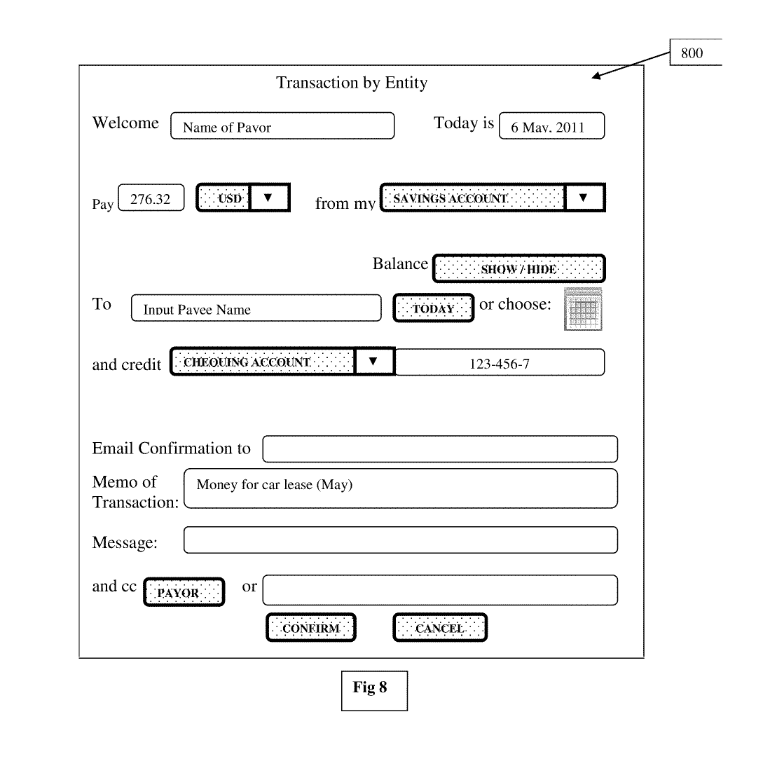

Referring to 707, the entity may receive a request input from payor of the details of the account of into which the money will be paid. Payor may select a ‘Chequing Account’ option from the drop down menu, as shown at FIG. 8 referred to below.

Proceeding to 709, entity may verify any number of criteria associated with the payor user interface. Should the UI be found not to be allowable for completion, entity may return an error notification to individual. Following such an error determination, the process may revert back to 707 where individual may correct the error by inputting modified criteria and/or additional criteria. If the UI is found to be allowable by entity in 709, the process may proceed to 711. FIG. 8 is an illustrative completed user interface 800 which may be generated at 709 by entity for request confirmation/cancellation of the example of the money transfer transaction in accordance with at least one aspect of the present disclosure. The UI shown at FIG. 8 may be seen by payor.

Returning to FIG. 7 at 711, payor may optionally confirm submission of the payor user interface for processing or confirm cancellation of the transaction. Since, in the example of the transfer between accounts, payor desires to confirm the transaction, payor enters a confirmation instruction at 711.

Proceeding into 713 entity may effect the transfer of monies from the savings account of payor as shown at 715 to the chequing account of payee as shown at 717 consistent with the criteria inputted at 707 and the process of the example of FIG. 7 may be complete.

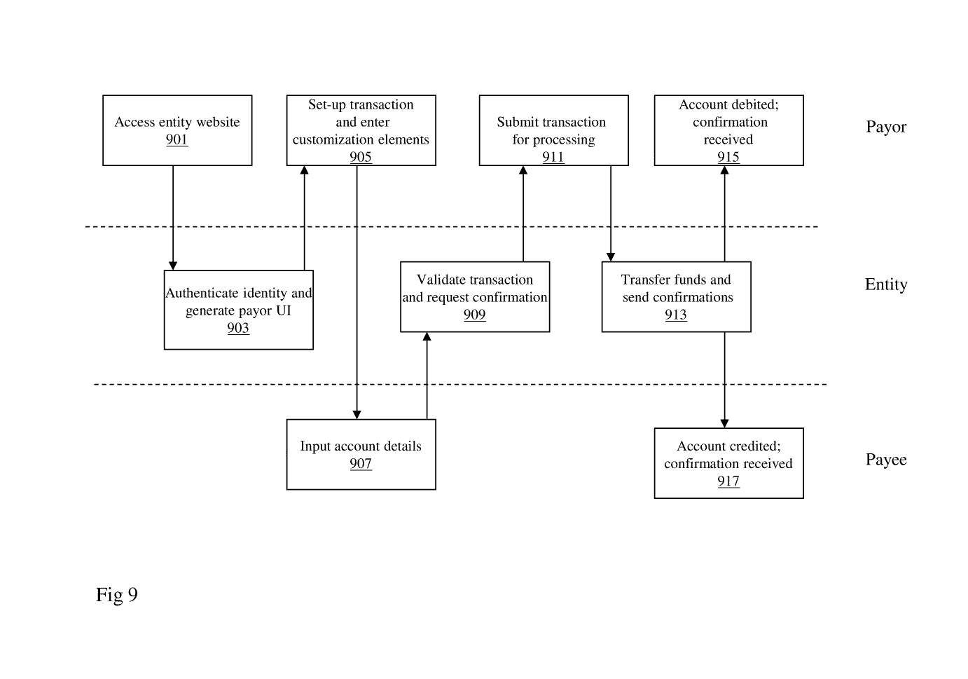

FIG. 9 is a flowchart of an illustrative method for setting up an electronic payment request by a payor and payment of an electronic payment by a payor to a payee in accordance with at least one aspect of the present disclosure. The illustrative example considered in FIG. 9 is a payor looking to transfer from her chequing account to the local electric utility the amount owing shown on the bill she received in the mail.

The description of FIG. 9 will coincide with an illustrative example of implementation of the steps in FIG. 9, however, it should be understood that this is but one illustrative example. For the example of FIG. 9, the areas assigned as Payor, Entity and Payee symbolize the operational aspects between payee, an entity and payor in the example of the payment of the utility bill.

It will be understood by those skilled in the art and its practice, the example of FIG. 9 may comprise one or more of the teachings and implementations of FIG. 5. So as not to encumber the present document by repetition, such teachings and implementations will not be repeated herein the description of FIG. 9, however the disclosure of FIG. 9 below shall be appreciated in conjunction with the teachings and implementations described above at FIG. 5 in the example of the babysitter. It will be further understood that the description of FIG. 9 is associated with a payor who, consequent to having completed the process of the example of FIG. 4 has received notice of association with the spontaneous online payment system according to the teachings and implementations shown at FIG. 4 and accordingly the spontaneous online payment system described herein may be used by payor from anywhere and at anytime.

The process starts and at 901 payor may access an entity website online in order to set up an electronic payment user interface for the payor that is for a transaction. In this example the entity website may be a financial entity where the payor maintains an account which can receive and disburse money, such as a chequing account and/or a savings account, or may be another entity interoperating with an entity where the payor maintains such an account or accounts. The transaction is the electric utility bill and paying the amount owing to the utility.

Referring to 903, the entity may permit payor to set up an electronic payment based on the online authentication of payor identity. Payor may set up a transaction by using a user interface generated by entity. In this example, the user interface may be that developed by payor to set up the elements of the transaction in the example of the Payment of the utility bill. Entity may display a user interface for payor which entity may populate with certain information corresponding to the user-defined criteria entered and stored as described at FIG. 4. Such information may include that information corresponding to the notice of association and the use of the spontaneous online payment system by payor.

Payor may set up the transaction at 905. It is understood that, at 905, any number of options for customizing the user interface may be generated for payor by the entity. For example, at 905 payor may suppress the default setting to send an Email transaction confirmation to the payee and/or may enter the name of payee, the electric utility

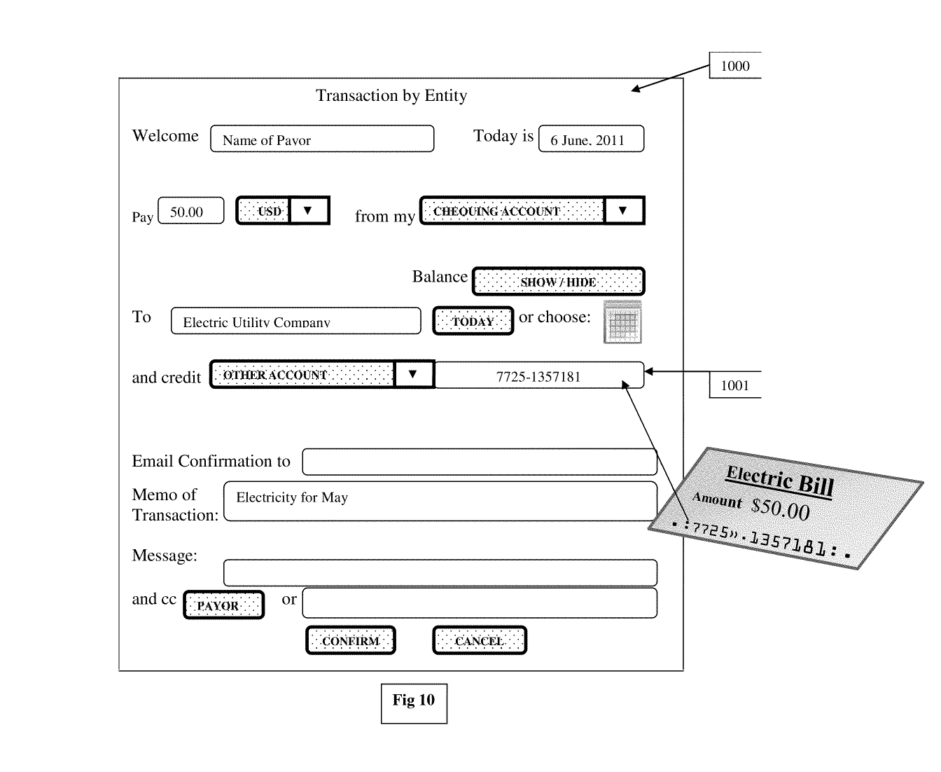

Referring to 907, the entity may receive a request input from payor of the account into which the money will be paid. Payor may enter data, for example the data notified to payor that is associated with maintaining account of payor at the electric utility, which data may coincide, for example, with a notification that may be seen by payor on the utility bill. An illustrative example of such input scenario is shown in FIG. 10 referred to below. In the example of the utility bill, payor may select ‘Other Account’ option from the drop down menu, as shown at 1001. Payor may enter the data in the text box boxed for entry of text. In the example of FIG. 10, the request input is demonstrated by way of transcribing a MICR encodification as shown by way of the stylized utility bill inserted for illustrative purposes at 1001, however it is understood that many such payor-specific account identifiers are well known in the art and as such many such embodiments may be may be practiced. It is also to be understood that the example of shown at 1001 is but one illustrative scenario and is to be accorded the broadest interpretation so as not to be as restrictive on the present description.

Returning to FIG. 9 proceeding to 909, entity may verify any number of criteria associated with the payor user interface. Should the UI be found not to be allowable for completion, entity may return an error notification to individual. Following such an error determination, the process may revert back to 907 where individual may correct the error by inputting modified criteria and/or additional criteria. If the UI is found to be allowable by entity in 909, the process may proceed to 911.

At 911, payor may optionally confirm submission of the payor user interface for processing or confirm cancellation of the transaction. Since, in the example of the utility bill payor desires to confirm the transaction, payor enters a confirmation instruction at 911.

Proceeding into 913 entity may effect the transfer of monies from the account of payor as shown at 915 to the account of payee as shown at 917 consistent with the criteria inputted at 907 and the process of the example of FIG. 9 may be complete.

While the invention, the illustrative systems and the methods as described herein by way of example and teachings embodying various aspects of the present disclosure, it will be understood that the invention is not limited to these embodiments. Modifications may be made by those skilled in the art and may be made without departing from the true spirit and scope of the present disclosure. For example, each of the elements of the aforementioned embodiments may be utilized alone or in combination or sub-combination with elements of the other embodiments. Therefore, the description is not to be regarded as restrictive on the present invention and accordingly the claims below should be accorded the broadest interpretations so as to encompass all such modifications and similar arrangements.

What is claimed is:

1. An on-line, computer-implementable disbursement and settlement system and method providing for any one person or entity of a population of persons or entities comprising:
Receiving a request to generate an online electronic user interface associated with an entity that is associated with a first individual for a first transaction to an account associated with an entity in accordance with at least one aspect of the present disclosure;
Receiving at least one first individual defined criterion associated with the electronic payment user interface that is for a first transaction;
Generating an Internet accessible address to the electronic payment user interface with an entity associated with first individual;
Receiving a request input from first individual online to access via the Internet accessible address the electronic user interface associated with first individual of the account associated with the entity;
Receiving at least one first individual defined criterion for a transaction in accordance with at least one aspect of the present disclosure;
Receiving an authorization input by first individual to make an electronic payment of a monetary quanta from an account of first individual to an account specified by first individual;
Permitting a payment of a monetary quanta from an account associated with first individual directly to an account specified by first individual in real-time and at any time and from anywhere;
Permitting transaction spontaneously without a request input authorization by entity a priori to any first transaction associated with any account specified by first individual for a transaction;
Permitting a payment directly from an account associated with first individual directly to an account specified by first individual without payment completion conditional on negotiation by individual holding the account specified by first individual of a notify and pay instrument, and
Permitting completion of a transaction without involving a stored value account.
A server and a funds exchange server (or a network of these) maintained by or on behalf of a service provider receiving and processing instructions from a user.

2. The method of claim 1, prior to receiving the request to generate the electronic payment user interface associated with the first individual for the first transaction to the account associated with the entity, the method further comprising authorizing the first individual as an authorized individual associated with the account associated with the entity.

3. The method of claim 1, further comprising:
Distributing to the first individual a notification of the electronic payment of the amount of monetary quanta paid to the account specified by first individual.
Distributing to any second individual, different from the first individual, a notification of the electronic payment of the amount of monetary quanta paid to the account specified by first individual.

4. The method of claim 1, further comprising:
Distributing to the first individual a notification of at least one first individual defined criterion associated with the electronic payment of the amount of monetary quanta paid to the account specified by first individual.
Distributing to any second individual, different from the first individual, a notification of at least one first individual defined criterion associated with the electronic payment of the amount of monetary quanta to the account specified by first individual.

5. The method of claim 1, further comprising the storing of at least one archival record of the first transaction associated with the first individual associated with the electronic payment of the amount of monetary quanta paid to the account specified by first individual.

6. The method of claim 1, further comprising the validation of the account of first individual is allowable by the entity for completion.

7. The method of claim 1, further comprising the validation of the amount of monetary quanta available in the account of first individual for transfer are allowable by the entity for completion.

8. The method of claim 1, further comprising the validation of the account specified by first individual as allowable by the entity for completion.

9. The method of claim 1, further comprising wherein the at least one first individual defined criterion associated with the electronic payment user interface for the first transaction includes a time interval point when monetary quanta are authorized for transfer to the account specified by first individual.

10. The method of claim 1, further comprising generating the electronic payment user interface associated with the first individual for the first transaction.

11. The method of claim 1, further comprising receiving at least one first individual defined criterion for a first transaction associated with the first individual for the first transaction.

12. The method of claim 1, further comprising receiving at least one first individual defined criterion for a transaction associated with the first individual for a first transaction associated with an account specified by first individual.

13. The method of claim 1, further comprising responsive to receiving, within the user interface, the authorization input associated with the account specified by first individual to transact monetary quanta with the account specified by first individual.

14. One or more computer readable medium comprising computer executable instructions that, when executed by at least one processor, causes the at least one processor to perform a method comprising:
Receiving a request to generate an online electronic user interface associated with an entity that is associated with a first individual for a first transaction to an account associated with an entity in accordance with at least one aspect of the present disclosure;
Receiving at least one first individual defined criterion associated with the electronic payment user interface that is for a first transaction;
Generating an Internet accessible address to the electronic payment user interface with an entity associated with first individual;
Receiving a request input from first individual online to access via the Internet accessible address the electronic user interface associated with first individual of the account associated with the entity;
Receiving at least one first individual defined criterion for a transaction in accordance with at least one aspect of the present disclosure;
Receiving an authorization input by first individual to make an electronic transfer of a monetary quanta from an account of first individual to an account specified by first individual;
Permitting a transfer of a monetary quanta from an account associated with first individual directly to an account specified by first individual in real-time and at any time from anywhere;
Permitting transaction spontaneously without a request input authorization by entity a priori to any first transaction associated with any account specified by first individual for a transaction;
Permitting a payment directly from an account associated with first individual directly to an account specified by first individual without payment completion provisional on negotiation by individual associated with an account specified by first individual of a notify and pay instrument, and,
Permitting completion of a transaction without involving a stored value account.

15. The one or more computer readable medium of claim 14, wherein the at least one first individual defined criterion associated with the electronic payment user interface for the first transaction includes a time interval point when monetary quanta are authorized for transfer into the account specified by first individual.

16. The one or more computer readable medium of claim 14, the method further comprising the method of claim 1, further comprising generating the electronic payment user interface associated with the first individual for the first transaction.

17. The one or more computer readable medium of claim 14, the method further comprising the method of claim 1, further comprising receiving at least one first individual defined criterion for a first transaction associated with the first individual for the first transaction.

18. An apparatus comprising:
at least one processor; and
at least one memory storing computer readable instructions that, when executed by the at least one processor, cause the apparatus to perform:
receiving a request to generate an online electronic user interface associated with an entity that is associated with a first individual for a first transaction to an account associated with an entity in accordance with at least one aspect of the present disclosure;
receiving at least one first individual defined criterion associated with the electronic payment user interface that is for a first transaction;
generating an Internet accessible address to the electronic payment user interface with an entity associated with first individual;
receiving a request input from first individual online to access via the Internet accessible address the electronic user interface associated with first individual of the account associated with the entity;
receiving at least one first individual defined criterion for a transaction in accordance with at least one aspect of the present disclosure;
receiving an authorization input by first individual to make an electronic transfer of a monetary quanta from an account of first individual to an account specified by first individual;
permitting a transfer of a monetary quanta from an account associated with first individual directly to an account specified by first individual in real-time and at any time from anywhere;
permitting transaction spontaneously without a request input authorization by entity a priori to any first transaction associated with any account specified by first individual for a transaction;
permitting a payment directly from an account associated with first individual directly to an account specified by first individual without payment completion provisional on negotiation by individual associated with an account specified by first individual of a notify and pay instrument, and
permitting completion of a transaction without involving a stored value account.

19. The apparatus of claim 18, the at least one memory storing additional computer readable instructions that, when executed by the at least one processor cause the apparatus to perform:
receiving a first request input from a first individual to access, via the Internet accessible address, the electronic payment user interface associated with the entity associated with the account of first individual, and
receiving a second request input from first individual to access, via the Internet accessible address, the electronic payment user interface associated with the entity associated with the account specified by first individual.

20. The apparatus of claim 18, the method further comprising the method of claim 1, further comprising permitting a payment directly from an account associated with a debit card, credit card, signature debit card, demand deposit account or any other type of account associated with a first individual to an account specified by first individual associated with a debit card, credit card, signature debit card, demand deposit account or any other type of account whether or not there exists an electronic payment user interface associated with the individual holding the account specified by first individual.
